(19) United States
(12) Patent Application Publication
(10) Pub. No.: US 2015/0350815 A1
(43) Pub. Date: Dec. 3, 2015

(54) METHOD, DEVICE AND SYSTEM FOR SHARING NETWORK

(71) Applicant: Spreadtrum Communications (Shanghai) Co., Ltd., Shanghai (CN)

(72) Inventors: Ming-Lun LEE, Shanghai (CN); Shiao-Ting HUANG, Shanghai (CN); Chau-Yan WANG, Shanghai (CN); Sung-Hui KAO, Shanghai (CN)

(21) Appl. No.: 14/684,840

(22) Filed: Apr. 13, 2015

(30) Foreign Application Priority Data
May 30, 2014 (CN) 201410240946.5

(51) Int. Cl. H04W 4/00; H04W 76/02

(52) U.S. Cl. CPC H04W 4/008; H04W 76/023

(57) ABSTRACT

A method, a device and a system for sharing network among a plurality of mobile terminals are provided. The method includes: connecting the plurality of mobile terminals with each other through short-range wireless communication; and when a first mobile terminal has a network request, transmitting a network packet corresponding to the network request to a network side by the first mobile terminal or a second mobile terminal, so as to share a network, wherein the second mobile terminal is connected to the first mobile terminal through short-range wireless communication and can access the network. The method can share network bandwidth among the plurality of mobile terminals, so as to utilize network bandwidth of each mobile terminal optimally.

### CROSS-REFERENCE TO RELATED APPLICATIONS

The present invention claims priority under 35 U.S.C. §119 to Chinese Application No. 201410240946.5 filed May 30, 2014, the entire content of which is incorporated herein by reference.

### TECHNICAL FIELD

The present disclosure generally relates to communication technology, and more particularly, to a method, a device and a system for sharing network.

### BACKGROUND

As the development of communication technology, mobile terminals can be connected to internet through 3rd-Generation (3G) mobile communication technology, 4th-Generation mobile communication technology, or Wireless Fidelity (WiFi) communication technology. After connected to the internet, the mobile terminals can obtain information, such that users can communicate, complete related tasks and perform a variety of other network operations, such as playing online games, etc.

In some implementations, maybe there are some mobile terminals with capability of being connected to the internet, while other mobile terminals don't. For example, some mobile terminals can be connected to the internet through a mobile data network, a WiFi wireless router, etc. However, other mobile terminals cannot be connected to the internet because of a limitation of data plan, or no network signals, etc. At this time, the mobile terminals capable of being connected to the internet can share network with mobile terminals which need to be connected to the internet.

Currently, a mobile terminal, capable of being connected to the internet through WiFi, can be set as a hotspot to share its 3G/4G network, so that other mobile terminals can be connected to this mobile terminal to use the network it shared. However, in the conventional technology, when the mobile terminal operates as a hotspot, it no longer can be connected to the internet through WiFi. In the prior art, it's difficult to realize a plurality of mobile terminals sharing network bandwidth with each other in order to obtain an optimal utilization of network bandwidth.

### SUMMARY

The present disclosure aims to solve the problem that the network bandwidth is hard to be shared among a plurality of mobile terminals.

A method for sharing network among a plurality of mobile terminals is provided in embodiments of the present disclosure. The method may include:

connecting the plurality of mobile terminals with each other through short-range wireless communication; and

when a first mobile terminal has a network request, transmitting a network packet corresponding to the network request to a network side by the first mobile terminal or a second mobile terminal, so as to share a network,

wherein the second mobile terminal is connected to the first mobile terminal through short-range wireless communication and can access the network.

In some embodiments, the method further includes: if the first mobile terminal cannot access the network, the first mobile terminal transmitting the network packet corresponding to the network request to the network side through the second mobile terminal.

In some embodiments, the short-range wireless communication may be realized by at least one of Bluetooth communication technology, Wireless Fidelity (WiFi) Direct communication technology or Near Field Communication (NFC) technology.

In some embodiments, transmitting the network packet corresponding to the network request to the network side by the first mobile terminal or a second mobile terminal includes:

if the first mobile terminal and the second mobile terminal are directly connected through short-range wireless communication, the first mobile terminal transmitting the network packet corresponding to the network request directly to the second mobile terminal; and

the second mobile terminal transmitting the network packet received from the first mobile terminal to the network side.

In some embodiments, transmitting the network packet corresponding to the network request to the network side by the first mobile terminal or a second mobile terminal includes:

if the first mobile terminal and the second mobile terminal are connected through at least one intermediate node, the first mobile terminal transmitting the network packet corresponding to the network request to the at least one intermediate node, wherein the at least one intermediate node is adapted for connecting the first mobile terminal and the second mobile terminal;

the at least one intermediate node transmitting the network packet received from the first mobile terminal to the second mobile terminal; and

the second mobile terminal transmitting the network packet received from the at least one intermediate node to the network side.

In some embodiments, the method further includes: after the first mobile terminal or the second mobile terminal obtains data corresponding to the network request from the network side, transmitting the data back to the first mobile terminal according to a corresponding data transmission mode.

In some embodiments, the first mobile terminal and the second mobile terminal can access the network through any one method of 3G or WiFi.

Correspondingly, a device for sharing network among a plurality of mobile terminals is provided in embodiments of the present disclosure. The device may include:

a connection unit, adapted for connecting the plurality of mobile terminals with each other through short-range wireless communication; and

a transmitting unit, adapted for, when a first mobile terminal has a network request, transmitting a network packet corresponding to the network request to a network side by the first mobile terminal or a second mobile terminal, so as to share a network,

wherein the second mobile terminal is connected to the first mobile terminal through short-range wireless communication and can access the network.

In some embodiments, the device further includes:

a first transmitting sub-unit, adapted for transmitting the network packet corresponding to the network request directly to the second mobile terminal when the first mobile terminal and the second mobile terminal are directly connected through short-range wireless communication; and

a second transmitting sub-unit, adapted for transmitting the network packet the second mobile terminal received from the first mobile terminal to the network side.

In some embodiments, the device further includes:

a third transmitting sub-unit, adapted for, when the first mobile terminal and the second mobile terminal are connected through at least one intermediate node, transmitting the network packet corresponding to the network request to the at least one intermediate node, wherein the at least one intermediate node is any one of the plurality of mobile terminals except the first mobile terminal and the second mobile terminal;

a fourth transmitting sub-unit, adapted for transmitting the network packet the at least one intermediate node received from the first mobile terminal to the second mobile terminal; and

a fifth transmitting sub-unit, adapted for transmitting the network packet the second mobile terminal received from the at least one intermediate node to the network side.

In some embodiments, the device further includes: an obtaining unit, adapted for, after the first mobile terminal or the second mobile terminal obtains data corresponding to the network request from the network side, transmitting the data back to the first mobile terminal according to a corresponding data transmission mode.

Correspondingly, a system for sharing network among a plurality of mobile terminals is also provided in embodiments of the present disclosure. The system may include: a first mobile terminal, a second mobile terminal and the above device for sharing network.

Compared with the conventional technology, embodiments of the present disclosure have following advantages.

The plurality of mobile terminals are connected through short-range wireless communication. When any one of the plurality of mobile terminals has a network request, the network can be accessed through the mobile terminal itself or another mobile terminal which is connected to the mobile terminal through short-range wireless communication. In the method of the present disclosure, network bandwidth can be shared among the plurality of mobile terminals, so that network bandwidth of each mobile terminal can be optimally utilized.

When a mobile terminal cannot be connected to a network directly, the mobile terminal can access the network through another terminal which is connected to the mobile terminal through short-range wireless communication and can access the network. Therefore, capability of the mobile terminal for accessing network is improved, and stability of interaction between the mobile terminal and the network is enhanced.

When the plurality of mobile terminals access the network through the shared network bandwidth among them, the plurality of mobile terminals can interact with the network through 3G, WiFi or other communication mode. The problem in the conventional technology that a mobile terminal cannot use WiFi communication mode when the mobile terminal opens a WiFi hotspot to share network, can be solved.

### BRIEF DESCRIPTION OF THE DRAWINGS

FIG. 1 illustrates a flow chart of a method for sharing network according to one embodiment of the present disclosure;

FIG. 2 illustrates a diagram of a system for sharing network according to one embodiment of the present disclosure;

FIG. 3 illustrates a flow chart of a method for sharing network according to another embodiment of the present disclosure; and

FIG. 4 illustrates a structure diagram of a device for sharing network according to one embodiment of the present disclosure.

### DETAILED DESCRIPTION

In the conventional technology, it cannot be achieved that a plurality of mobile terminals share network bandwidth with each other.

In order to solve the above problem, a method for sharing network is provided in embodiments of the present disclosure. As shown in FIG. 1, step S1 is performed firstly. That is, a plurality of mobile terminals are connected with each other through short-range wireless communication.

In order to share network bandwidth among the plurality of mobile terminals, a short-range wireless communication technology may be used to connect the mobile terminals which need to share network bandwidth. The mobile terminals may be mobile phones, laptops, tablet PCs or other terminals which have short-range communication capabilities.

The short-range wireless communication technology includes Bluetooth communication technology, WiFi Direct communication technology, Near Field Communication (NFC) technology, etc. The short-range wireless communication technology includes but not limited to the above listed communication technology.

Based on the short-range communication capabilities of Bluetooth, WiFi Direct, etc, the mobile terminals supporting the Bluetooth, WiFi Direct or other functions can be connected to form a local area network, so as to obtain a capability to share network bandwidth among the connected mobile terminals.

In step S2, when a first mobile terminal has a network request, a network packet corresponding to the network request is transmitted to a network side through the first mobile terminal or a second mobile terminal, so as to share the network.

In order to simplify the description, the mobile terminal having a network request in the mobile terminals which are connected with each other through a short-range wireless communication technology is referred to as a first mobile terminal in the present disclosure. The mobile terminal which is connected, directly or indirectly, to the first mobile terminal and has a capability to connect the network is referred to as the second mobile terminal.

The second mobile terminal can be directly connected to the first mobile terminal through the short-range wireless communication technology, or can be connected to the first mobile terminal through another terminal in the plurality of mobile terminals. In the present disclosure, the mobile terminal used to connect the first mobile terminal and the second mobile terminal is referred to as an intermediate node. It should be understood that there may be one or more than one intermediate node between the mobile terminal and the second mobile terminal.

When the plurality of mobile terminals are connected through the short-range wireless communication technology, the mobile terminals connected to the first mobile terminal and having a capability to connect the network may be more than one. That is, there may be more than one second mobile terminal.

The network packet is obtained by packaging data of the network request based on certain communication protocols, wherein the data of the network request is packaged by the mobile terminals which need to share network based on the communication protocols. The network packet can be transmitted, received and identified by the above mobile terminals which need to share network.

When the first mobile terminal has a network request, the network package corresponding to the network request can be transmitted to the network side through the first mobile terminal, and also can be transmitted to the network side through the second mobile terminal which is directly or indirectly connected to the first mobile terminal through the short-range wireless communication technology, so that the network bandwidth can be shared among the plurality of mobile terminals.

The method for sharing network provided in embodiments of the present disclosure can achieve network share among the plurality of mobile terminals, so that the network bandwidth of each mobile terminal can be optimally utilized.

In order to clarify the objects, characteristics and advantages of the disclosure, the embodiments of the present disclosure will be described in detail in conjunction with the accompanying drawings.

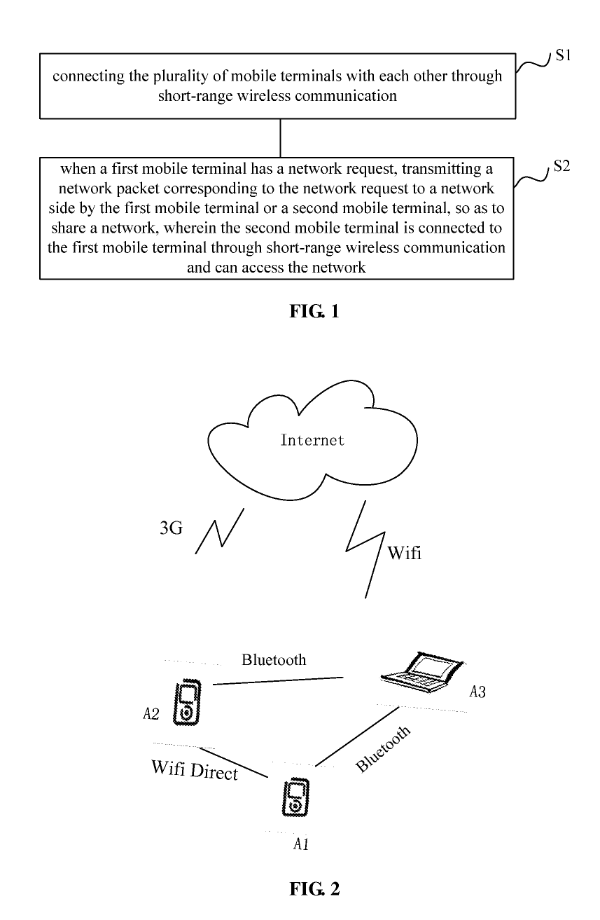

FIG. 2 is a system for sharing network according to one embodiment of the present disclosure. As shown in FIG. 2, there are 3 mobile terminals: A1, A2 and A3, A1 and A2 may be connected through WiFi Direct, A1 and A3 may be connected through Bluetooth, and A2 and A3 may be connected through Bluetooth. The mobile terminals can be connected with each other automatically as long as they have corresponding short-range wireless communication functions. The specific connection mode is not limited herein.

Every two mobile terminals are connected to each other in FIG. 2. However, in some embodiments, not any two mobile terminals can be wirelessly connected to each other. Also taking FIG. 2 as an example, A1 and A2 may be connected through WiFi Direct, A1 and A3 may be connected through Bluetooth, but A2 and A3 cannot be connected through a short-range wireless communication technology. The connection modes are not limited herein. Mobile terminals, which can be directly or indirectly connected with each other through a short-range wireless communication technology, can use each other's network bandwidth, so as to share network bandwidth.

Referring to FIG. 2, A1 is a first mobile terminal. That is, A1 has a network request. Then, A1 may transmit a network packet corresponding to the network request to a network side, wherein the network side may be the internet network shown in FIG. 2. In some embodiments, A1 may transmit the network packet to A3 through Bluetooth communication technology, and then A3 may transmit the network packet to the internet network. In some embodiments, A1 may transmit the network packet to A2 through WiFi Direct communication technology, and then A2 may transmit the network packet to the internet network. In some embodiments, A1 may transmit the network packet to A2 through WiFi Direct communication technology, A2 may transmit the network packet to A3 through Bluetooth communication technology, and then A3 may transmit the network packet to the internet network. In a mode that: A1 transmits the network packet to A2 through WiFi Direct communication technology, A2 transmits the network packet to A3 through Bluetooth communication technology, and then A3 transmits the network packet to the internet network, A2 is an intermediate node between the first mobile terminal A1 and the second mobile terminal A3.

The network packet corresponding to the network request of A1 can be transmitted to the internet network by any one of A1, A2 or A3. When any one of A1, A2 or A3 transmits the network packet to the internet network, the internet network can be accessed through a network communication mode supported by A1, A2 or A3. For example, 3G or WiFi may be used to connect the internet network.

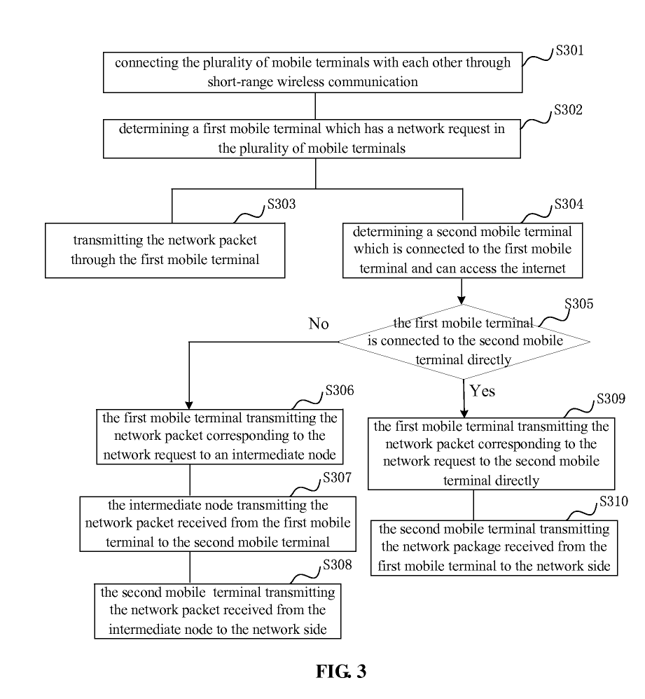

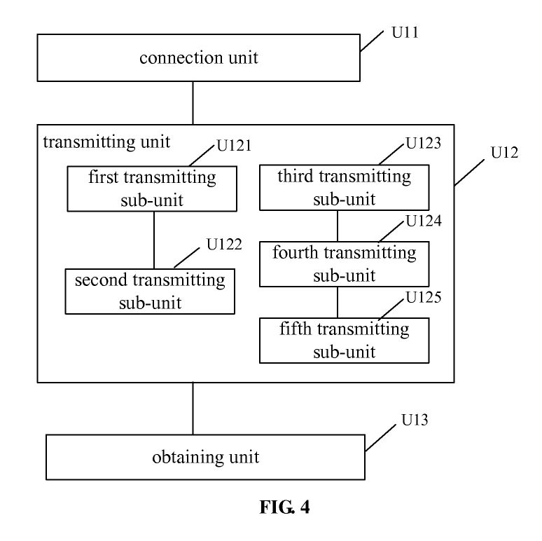

The method for sharing network will be described in detail in conjunction with a flow chart. FIG. 3 is a flow chart of the method for sharing network according to one embodiment of the present disclosure. As shown in FIG. 3, step S301 is performed firstly. In the step S301, connecting a plurality of mobile terminals with each other through short-range wireless communication.

In order to share network bandwidth among the plurality of mobile terminals, a short-range wireless communication technology may be used to connect the mobile terminals which need to share network bandwidth. The mobile terminals should have short-range wireless communication capabilities, such as Bluetooth communication technology, WiFi Direct communication technology, etc. Moreover, the plurality of mobile terminals can package data of the network request into a network packet which can be exchanged between different mobile terminals.

In step S302, determining a first mobile terminal which has a network request in the plurality of mobile terminals.

The terminal which has a network request is determined as the first mobile terminal. The first mobile terminal can package data of the network request into a network packet, and can transmit the network packet to a network side itself or through a second mobile terminal which is connected to the first mobile terminal and can access the network, so as to obtain corresponding data from the network side.

After the step S302, step S303 is performed.

In the step S303, transmitting the network packet through the first mobile terminal.

The first mobile terminal may transmit the network packet to the internet network directly, so as to achieve an interaction with the internet network. In this embodiment, the first mobile terminal has a capability to access the internet network through 3G or WiFi.

Data corresponding to the network packet can be obtained from the internet network. The data from the internet network can be transmitted back to the first mobile terminal which initiates the network request by using a corresponding data transmission mode between the first mobile terminal and the network, so as to achieve access to the network.

In some embodiments, after the step S302, step S304 may be performed.

In the step S304, determining a second mobile terminal which is connected to the first mobile terminal and can access the internet.

The second mobile terminal can be directly connected to the first mobile terminal using a short-range wireless communication technology, and also can be connected to the first mobile terminal through an intermediate node using the short-range wireless communication technology.

When more terminals than one are connected with each other through a short-range wireless communication technology, for the first mobile terminal, there may be more than one second mobile terminal directly or indirectly connected to the first mobile terminal.

In step S305, determining whether the first mobile terminal is connected to the second mobile terminal directly.

Because the first mobile terminal may be connected to the second mobile terminal directly or through an intermediate node via a short-range wireless communication technology, a connection mode between the first mobile terminal and the second mobile terminal can be determined in this step.

If a determining result of the step S305 is no, namely, if the first mobile terminal and the second mobile terminal are connected through an intermediate node, step S306 is performed. Otherwise, step S309 is performed.

In the step S306, the first mobile terminal transmits the network packet corresponding to the network request to an intermediate node.

After the step S306, step S307 is performed. That is, the intermediate node transmits the network packet received from the first mobile terminal to the second mobile terminal.

Step 308 is performed after the step S307. The second mobile terminal transmits the network packet received from the intermediate node to the network side.

In some embodiments, if a determining result of the step S305 is yes, that is, if the first mobile terminal and the second mobile terminal are connected directly, step S309 is performed.

In the step S309, the first mobile terminal transmits the network packet corresponding to the network request to the second mobile terminal directly.

Step S310 is performed after the step S309. The second mobile terminal transmits the network package received from the first mobile terminal to the network side.

In some embodiments, there may be more than one second mobile terminal. For any one of the more than one second mobile terminal, if the first mobile terminal is directly connected to that second mobile terminal, the network packet corresponding to the network request can be transmitted to the network side by performing steps S309 and S310. If the first mobile terminal is connected to the second mobile terminal through an intermediate node, the network packet corresponding to the network request can be transmitted to the network side by performing steps S306 to S308. The operations in the steps S305 to S310 can be performed by any one of the more than one second mobile terminal, so that the network packet corresponding to the network request can be transmitted to the network side by any one of the more than one second mobile terminal.

In the above procedure, when each mobile terminal transmits the network packet, corresponding transmission mode between connected terminals can be used to transmit the network packet. After data corresponding to the network packet is obtained from the internet network, the data can be transmitted back to the first mobile terminal which initiates the network request by using a specific data transmission mode among the second mobile terminal, the first mobile terminal and the intermediate node, so as to achieve access to the network.

In one embodiment, the first mobile terminal and the second mobile terminal can access the network according to network communication modes they supported. For example, 3G or WiFi hotspot may be used to access the network, so as to achieve interaction with the network. In the conventional technology, if a WiFi hotspot is used to access network, the network cannot be connected by a WiFi communication mode but only can be connected by a 3G communication mode. The above problem in the conventional technology can be resolved by the method of the present disclosure.

In one embodiment, when a first mobile terminal initiates a network request, a network can be accessed through the first mobile terminal itself or a second mobile terminal directly or indirectly connected to the first mobile terminal. In some embodiments, if the first mobile terminal itself doesn't has a capability to access a network and cannot access the network, the first mobile terminal can transmit a network packet corresponding to the network request to a network side through a second network terminal which is connected to the first mobile terminal and has a capability to access the network, so as to improve capability of the mobile terminal for accessing network and enhance stability of interaction between the mobile terminal and the network.

In the method for sharing network provided in embodiments of the present disclosure, a plurality of mobile terminals are connected with each other through short-range wireless communication. When any one of the plurality of mobile terminals has a network request, a network can be access through the mobile terminal itself or another mobile terminal which is connected to the mobile terminal through short-range wireless communication. In the method, network bandwidth can be shared among the plurality of mobile terminals, and network bandwidth of each mobile terminal can be optimally utilized.

Corresponding to the above method for sharing network, a device for sharing network is provided in embodiments of the present disclosure. The device may include a connection unit U11, and a transmitting unit U12.

The connection unit U11 is adapted for connecting a plurality of mobile terminals with each other through short-range wireless communication.

The transmitting unit U12 is adapted for, when a first mobile terminal has a network request, transmitting a network packet corresponding to the network request through the first mobile terminal or a second mobile terminal to share a network, wherein the second mobile terminal is connected to the first mobile terminal through a short-range wireless communication technology and has a capability to access the network.

The transmitting unit U12 may include a first transmitting sub-unit U121 and a second transmitting sub-unit U122.

The first transmitting sub-unit 121 is adapted for transmitting the network packet corresponding to the network request directly to the second mobile terminal when the first mobile terminal and the second mobile terminal are directly connected through the short-range wireless communication technology.

The second transmitting sub-unit U122 is adapted for transmitting the network packet the second mobile terminal received from the first mobile terminal to the network side.

The transmitting unit U12 may include a third transmitting sub-unit U123, a fourth transmitting sub-unit U124 and a fifth transmitting sub-unit U125.

The third transmitting sub-unit U123 is adapted for, when the first mobile terminal and the second mobile terminal are connected through at least one intermediate node, transmitting the network packet corresponding to the network request to the at least one intermediate node, wherein the intermediate may be any one of the plurality of mobile terminals except the first mobile terminal and the second mobile terminal.

The fourth transmitting sub-unit U124 is adapted for transmitting the network packet received from the at least one intermediate node to the second mobile terminal.

The fifth transmitting sub-unit U125 is adapted for transmitting the network packet the second mobile terminal received from the intermediate node to the network side.

The device may further includes an obtaining unit U13 adapted for, after the first mobile terminal or the second mobile terminal obtains data corresponding to the network request, transmitting the data back to the first mobile terminal according to a corresponding data transmission mode.

Corresponding to the device for sharing network, a system for sharing network is provided in embodiments of the present disclosure. The system is used to share networks among a plurality of mobile terminals. The system may include a first mobile terminal and a second mobile terminal, and the system further includes the device for sharing network described above.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A method for sharing network among a plurality of mobile terminals, comprising:
connecting the plurality of mobile terminals with each other through short-range wireless communication; and
when a first mobile terminal has a network request, transmitting a network packet corresponding to the network request to a network side by the first mobile terminal or a second mobile terminal, so as to share a network,
wherein the second mobile terminal is connected to the first mobile terminal through short-range wireless communication and can access the network.

2. The method according to claim 1, further comprising: if the first mobile terminal cannot access the network, the first mobile terminal transmitting the network packet corresponding to the network request to the network side through the second mobile terminal.

3. The method according to claim 1, wherein the short-range wireless communication is realized by at least one of Bluetooth communication technology, Wireless Fidelity (WiFi) Direct communication technology or Near Field Communication (NFC) technology.

4. The method according to claim 1, wherein transmitting the network packet corresponding to the network request to the network side by the first mobile terminal or the second mobile terminal comprises:
if the first mobile terminal and the second mobile terminal are directly connected through short-range wireless communication, the first mobile terminal transmitting the network packet corresponding to the network request directly to the second mobile terminal; and
the second mobile terminal transmitting the network packet received from the first mobile terminal to the network side.

5. The method according to claim 1, wherein transmitting the network packet corresponding to the network request to the network side by the first mobile terminal or the second mobile terminal comprises:
if the first mobile terminal and the second mobile terminal are connected through at least one intermediate node, the first mobile terminal transmitting the network packet corresponding to the network request to the at least one intermediate node, wherein the at least one intermediate node is adapted for connecting the first mobile terminal and the second mobile terminal;
the at least one intermediate node transmitting the network packet received from the first mobile terminal to the second mobile terminal; and
the second mobile terminal transmitting the network packet received from the at least one intermediate node to the network side.

6. The method according to claim 1, further comprising: after the first mobile terminal or the second mobile terminal obtains data corresponding to the network request from the network side, transmitting the data back to the first mobile terminal according to a corresponding data transmission mode.

7. The method according to claim 1, wherein the first mobile terminal and the second mobile terminal can access the network through any one method of 3G or WiFi.

8. A device for sharing network among a plurality of mobile terminals, comprising:
a connection unit, adapted for connecting the plurality of mobile terminals with each other through short-range wireless communication; and
a transmitting unit, adapted for, when a first mobile terminal has a network request, transmitting a network packet corresponding to the network request to a network side by the first mobile terminal or a second mobile terminal, so as to share a network,
wherein the second mobile terminal is connected to the first mobile terminal through short-range wireless communication and can access the network.

9. The device according to claim 8, further comprising:
a first transmitting sub-unit, adapted for transmitting the network packet corresponding to the network request directly to the second mobile terminal when the first mobile terminal and the second mobile terminal are directly connected through short-range wireless communication; and
a second transmitting sub-unit, adapted for transmitting the network packet the second mobile terminal received from the first mobile terminal to the network side.

10. The device according to claim 8, further comprising:
a third transmitting sub-unit, adapted for, when the first mobile terminal and the second mobile terminal are connected through at least one intermediate node, transmitting the network packet corresponding to the network request to the at least one intermediate node, wherein the at least one intermediate node is any one of the plurality of mobile terminals except the first mobile terminal and the second mobile terminal;
a fourth transmitting sub-unit, adapted for transmitting the network packet the at least one intermediate node received from the first mobile terminal to the second mobile terminal; and
a fifth transmitting sub-unit, adapted for transmitting the network packet the second mobile terminal received from the at least one intermediate node to the network side.

11. The device according to claim 8, further comprising: an obtaining unit, adapted for, after the first mobile terminal or the second mobile terminal obtains data corresponding to the network request from the network side, transmitting the data back to the first mobile terminal according to a corresponding data transmission mode.

12. A system for sharing network among a plurality of mobile terminals, comprising: a first mobile terminal, a second mobile terminal and a device for sharing network among a plurality of mobile terminals, wherein the device comprises:
a connection unit, adapted for connecting the plurality of mobile terminals with each other through short-range wireless communication; and
a transmitting unit, adapted for, when the first mobile terminal has a network request, transmitting a network packet corresponding to the network request to a network side by the first mobile terminal or the second mobile terminal, so as to share a network,
wherein the second mobile terminal is connected to the first mobile terminal through short-range wireless communication and can access the network.

13. The system according to claim 12, further comprising:
a first transmitting sub-unit, adapted for transmitting the network packet corresponding to the network request directly to the second mobile terminal when the first mobile terminal and the second mobile terminal are directly connected through short-range wireless communication; and
a second transmitting sub-unit, adapted for transmitting the network packet the second mobile terminal received from the first mobile terminal to the network side.

14. The system according to claim 12, further comprising:
a third transmitting sub-unit, adapted for, when the first mobile terminal and the second mobile terminal are connected through at least one intermediate node, transmitting the network packet corresponding to the network request to the at least one intermediate node, wherein the at least one intermediate node is any one of the plurality of mobile terminals except the first mobile terminal and the second mobile terminal;
a fourth transmitting sub-unit, adapted for transmitting the network packet the at least one intermediate node received from the first mobile terminal to the second mobile terminal; and
a fifth transmitting sub-unit, adapted for transmitting the network packet the second mobile terminal received from the at least one intermediate node to the network side.

15. The system according to claim 12, further comprising: an obtaining unit, adapted for, after the first mobile terminal or the second mobile terminal obtains data corresponding to the network request from the network side, transmitting the data back to the first mobile terminal according to a corresponding data transmission mode.
